(19) United States
(12) Patent Application Publication
(10) Pub. No.: US 2017/0367313 A1
(43) Pub. Date: Dec. 28, 2017

(54) CRAWLING INSECT TRAP

(71) Applicants: AB7 INNOVATION S.A.S.U., Deyme (FR); OVALIE Innovation S.A.S., Auch (FR)

(72) Inventors: René CHELLE, Grepiac (FR); Vincent HARRACA, Montesquieu Lauragais (FR); Arnaud VILBERT, Baziege (FR); Stéphane BALLAS, Castelnau Barbarens (FR); Sébastien HIREL, Nogaro (FR); Thierry VERONESE, Lautignac (FR); Anne Marie BUSUTTIL, Auch (FR)

(21) Appl. No.: 15/538,736

(22) PCT Filed: Dec. 23, 2015
(86) PCT No.: PCT/FR2015/000240

§ 371 Date: Jun. 22, 2017

(30) Foreign Application Priority Data
Dec. 23, 2014 (FR) 1402998

(51) Int. Cl. A01M 1/10; A01M 1/02

(52) U.S. Cl. CPC A01M 1/103; A01M 1/02; A01M 2200/011

(57) ABSTRACT

The present invention relates to an insect trap (1) including a hollow body (2) formed by two elements interlocking each other, the outer surface (3) of said hollow body (2) is pierced by a plurality of openings (4), each opening (4) extending into a tunnel (7) facing the inside of the hollow body (2), characterized in that removable tunnel elements (11) are inserted at the surface (3) of said hollow body (2) via the upper portion (13) of same, wherein said upper portion fits with the insert hole made directly in the hollow body (2). Said tunnel elements (11) comprises a lower portion that corresponds to the tunnel (7) and the inner diameter and the length of which can be adapted to the dimensions of the target insect in such a way that they force said insect located therein to move in one direction toward the inside of the hollow body (2) but do not allow said insect to turn around by pivoting on itself.

The present invention relates to the field of devices used in insect pest control. More precisely, the present invention relates to a trap for capturing crawling insects in a location subject to pest control.

More particularly, the object of the present invention is to provide a trap for crawling insects comprising a hollow body, pierced with a plurality of openings on an outer surface thereof. Said hollow body has a variable geometric shape which is formed by two elements that interlock with each other to allow emptying. Each opening forms a tunnel extending inwardly into the hollow body, the inward end of the tunnel being open-ended. The tunnel is designed such that its end that is inside the hollow body does not reach its bottom of the hollow body. Crawling insects entering the openings have no way to get out and are thus trapped alive in the hollow body. When in use, the trap can be provided in any position and still maintain its efficiency.

To fight against pest insects, there are well known techniques which are also specific to the type of insect considered. This is even more appropriate depending on whether flying insects or crawling insects are considered. Indeed, some have observed that the overall look of the trap has an impact on how much the insects are attracted to a given trap. The specificity of a trap depends on its look, and on its accessibility with respect to the targeted insects (Vale 1982, Brightwell et al. 1991). Other parameters such as opacity or color are additional criteria that must be taken into account when designing a trap, as shown in laboratory and field studies on flies and beetles (Finch & Skinner, 1974).

To improve the efficiency of traps, the prior art abundantly describes using attractive molecules, either alone or associated with insecticides. However, some insecticides are becoming less efficient because of targeted insects that develop some forms of resistance. Moreover, some insecticides are harmful for human health and for the environment, thus their use must be limited if they do not meet standard regulations (Steelman 2008, Chernaki-Leffer et al. 2011).

The litter beetle, Alphitobius diaperinus (Panzer 1797), which is between 5 and 7 mm long, is a pest insect that is hard to eradicate in poultry breeding, since it is well adapted to warm and wet conditions (Dunford & Kaufman 2012). Poultry farm buildings are thus particularly invaded, where the invasion occurs in patches (Salin et al. 2000, Amir & Nadir 2009). This high concentration of A. diaperinus is said buildings causes health problems, such as damages to the digestive system of birds (Geden & Hogsette 2001, Dinev 2013), transmission of viruses (Dunford & Kaufman 2012), bacteria (Geden & Hogsette 2001, Dinev 2013) or protozoa (Goodwin & Waltman 1996), and economic impacts related to the degradation of isolating materials of the buildings by larvae as well as by adults (Geden & Hogsette 2001, Dunford & Kaufman 2012).

Patent DE19531981 discloses an insect trap comprising a hollow body formed by a paper tube that can retract and extend like an accordion. The tube is perforated along its outside surface. When in use, the tube is vertically extended and apertures with an ellipse shape by which the insects can get into the trap. A funnel, which can be made of plastic, is provided by each end of the tube. Each funnel is also perforated. However, some of the insects among those captured in the tube get to escape by the apertures, by crawling up the inner wall of the tube.

Patent FR2750572 discloses an insect trap comprising a rectangular pyramid plastic box. Accessing inside the trap is possible only from the bottom, by means of at least one entrance aperture provided on the base. The inner wall of the box is provided with insecticide and baits. The trap must be suspended at a given height to allow insects to get in. However, insects that are not killed by the insecticide can easily get out from the trap by the same entrance aperture.

To prevent insects getting out from the trap once they are trapped in, JP2012110294 discloses a device comprising a reservoir perforated with apertures, and a brush with a plurality of flexible pins, the brush being installed right under the apertures inside the reservoir, such that insects can get in by pushing on the pins but cannot get out. Patent documents U.S. Pat. No. 1,618,513, U.S. Pat. No. 2,741,066 and US2011078941 describe traps designed for a similar purpose. None of these documents disclose apertures that extend as inwardly-oriented tunnels into the reservoir.

Patent GB2386115 discloses an insect trap comprising a hollow cylindrical rod with a conical end serving as a diaphragm and which is inserted into a cylindrical container having a bottleneck. The bottleneck, covered by a membrane made of a soft material, is automatically closed as the rod is withdrawn, thereby preventing trapped insects to escape the container. Three inwardly-extending funnel-type apertures are provided on the outer surface of the hollow rod. However, when in use, the trap must be provided in a vertical position. Moreover, funnels allow flying insects to get in, and unfortunately allow insects to get out by the same aperture by crawling up the inner wall of the rod.

European patent EP1959729 discloses a trap device for frugivorous flying insects. This device comprises a transparent lid combined with an opaque reservoir bucket with a frustoconical bottom having colors that attract insects. Three tunnels are provided radially on a side of the reservoir to allow entry of insects and to facilitate the diffusion of attractants placed in the bottom of the bucket. A diffuser impregnated with attractive aqueous substances combined with an insecticide must be introduced into the device. When in use, the device is suspended to tree branches at a height from the ground ranging between 1.4 m and 1.8 m. The efficiency of the trap is limited by the depletion of the attractants and the insecticide. Moreover, some of the flying insects that are trapped find their way out of the trap. Finally, when in use, the trap must be placed in a vertical position.

International application WO2010069503 aims at improving some of the technical features described in document EP1959729 by insisting on the role played by the three tunnels situated on the side of the reservoir bucket in order to improve the efficiency of the trap. Thanks to the transparent cover, the light illuminates the inside of the reservoir bucket except for the inside of the three tunnels, which remains dark. Under the effect of phototropism, the flies are attracted by the light inside the bucket and cross the tunnel. Since the luminosity inside the trap is relatively uniform, the captured flies are disoriented in search of a way out and get tired and then killed by the insecticide. The three tunnels are arranged radially so as to facilitate the circulation of the air and thus the diffusion of the attractant, said tunnels sometimes being withdrawn by the user. However, some flies can still come out through the same orifice because the intensity of the light perceived in front of the inner end of the tunnel is greater compared to the rest of the inside of the trap, so its effectiveness depends on the brightness on that day. In addition, when in use, the trap must be positioned vertically.

Patent EP2559338 describes a flying insect trap comprising a hollow body and a lid, the side of the hollow body being provided with four fixed tunnels inwardly extending inside the hollow body. To improve the capture rate, the lower part of the hollow body is opaque and the lid is translucent.

Patent CA2730828 discloses an earwig trap comprising a reservoir to contain liquid and a removable lid. At mid-height of the side wall of the reservoir, there are fixed tunnels of a circular section which extend inwardly. Each tunnel, the inner wall of which is smooth, is slightly inclined downwardly with respect to a horizontal plane. In order to increase the capture rate, on the one hand, reflective strips are provided on a portion of the outer surface of the reservoir; on the other hand, the lid may comprise a wick comprising an attractant that extends towards the inside of the reservoir.

U.S. Pat. No. 1,364,949 discloses a fly trap, of which the hollow body consists of two interlocking portions; six fixed tunnels of a circular section are distributed radially with respect to the joining line of the two portions. The apex of the hollow body is provided with a handle for suspending it and the base portion must be flat or is provided with feet so that the trap can remain in a stable vertical position.

Patent EP 2489261 discloses a trap for frugivorous insects comprising a hollow body divided into two parts which interlock with each other; the upper part being transparent, the ceiling of which is coated with at least one contact insecticide; the lower part corresponding to a tank comprises at least one fixed tunnel which extends inwardly, some of the tunnels are situated radially and at least one tunnel is situated on the base portion.

The orientation of an animal in space through its sense of touch is a very common behavior called thigmotactism. It can be defined as the fact that a moving animal coming into contact with a surface tends to avoid the loss of this surface contact (Treit and Fundytus, 1989). The cockroach is an example of an insect with a very strong thigmotactic behavior (Bell, 1981), but this behavior is almost universal (Jeanson et al., 2004). This thigmotactic behavior is used in various patents such as U.S. Pat. No. 4,784,086 and U.S. Pat. No. 5,097,641, in order to divert the movement of crawling insects and thus avoid their displacement towards a source to be protected, or DE3221985, in order to direct them into an area containing a pesticide. Patent application WO2010098917A1 describes the use of thigmotactism of bed bugs to cause them to enter a trap.

All the traps disclosed by the prior art are not specifically adaptable to crawling insects, still less to darkling beetles in poultry farm buildings in the sense that, in order to increase the probability of capture, these traps must be combined either with liquid, either with insecticides or to shades of color or luminosity. Moreover, they must adopt a particular and fixed position when being used. Otherwise the captured insects are likely to escape, thereby reducing their effectiveness. Similarly, the tunnels are fixed because they are molded directly with the hollow body and their dimensions are also fixed so that they are only suitable for capturing a single type of target insect.

The present invention addresses the aforementioned disadvantages by providing an improved trap capable of capturing several types of insects, particularly crawling insects, keeping a single hollow body but only removing the tunnels for their replacement, said trap having a high probability of capture, without using any liquid to drown the captured insects, or any shade of color. When in use, it may be provided directly on the ground since it is capable of rolling on itself, and it must operable in any position, including a horizontal position, with the same efficiency. This trap is particularly suitable for capturing both the larvae and adults of darkling beetles in poultry farm buildings, as well as insects found in homes, such as various types of cockroaches and even houseflies.

Since insects are bilaterally symmetrical, the dimensions mentioned in the text are based on the cross-section planes of such organisms; the dimensions consisting of the length, width and height of the insect. Thus, in the context of the invention, “width” refers to the longest axis in the front plane of the insect. For example, for insects of substantially tubular shape, the width corresponds to their diameter. The body part of the insect from which this axis is measured is the largest one from: the head or the thorax including the wings or the abdomen.

The term “length” of the insect refers to the longest axis in the sagittal plane of the insect.

The term “height” of the insect refers to the longest axis between the ground and the top of the insect in the transverse plane.

The term “smooth” wall refers to a wall of surface that is smooth enough for the insect to experience great difficulties to move thereon.

The term “adaptable”, regarding the tunnel dimensions with respect to the dimensions of the insect, refers to the fact that the insect is forced to progress in the tunnel unidirectionally toward the inside of the trap without allowing it to turn around by pivoting on itself, either over the entire length of the tunnel, for example for a cylindrical tunnel, or on at least a part thereof for a frustoconical or funnel-shaped tunnel. It has been observed that, due to thigmotactic behavior, some insects have a propensity to move unidirectionally when they are in a restricted space, this being all the more true when a part of their body makes contact with an obstacle.

A first object of the present invention is a device formed by two elements interlocking with each other, as an improved crawling insect trap that can be placed in any position when in use. In other words, the trap according to the invention can be placed on the ground both in horizontal or vertical position. The device traps crawling insects so that once inside the trap, it is totally impossible for them to come out. The trap according to the present invention does not involve any shade of color to attract insects.

A second object of the present invention is to provide a method for capturing several types of insects, in particular crawling insects, in particular darkling beetles in poultry farms using the trap according to claim 1.

Thus, the first object of the present invention is to provide an insect trap comprising a hollow body formed by two interlocking elements, the outer surface of said hollow body is pierced with several openings allowing the insect to be captured to get into the inside of the trap, each opening extending as a tunnel oriented toward the inside of the hollow body, characterized in that removable tunnel elements are inserted, at an upper part thereof, on the surface of said hollow body and fit with insert holes provided directly and the hollow body, said tunnel element comprising a lower portion corresponding to the tunnel, the inner diameter and length of which are adaptable to the dimensions of the target insect so that when said insect is located therein, it is forced to progress unidirectionally toward the inside of the hollow body but do not allow it to turn around by pivoting on itself either over the entire length or on at least a part of said tunnel; and in that the inner wall of said tunnel is rough to allow the insect to progress therethrough while the outer wall is smooth to prevent insects caught in the hollow body from climbing on said tunnel to exit through the opening.

The inside diameter of said tunnel is between 1.3 and 2 times the width of the insect and the length of said tunnel is between two and seven times, preferably three times, than the length of the insect. This length is between 1 cm and 4 cm and the inside diameter is between 0.5 cm and 0.8 cm for the darkling beetle, for example.

Advantageously, the dimensions, namely the inside diameter and the length of the tunnel, can be lengthened or shortened in relation with the dimensions of the insect to be captured, as well as the shape of the tunnel which may be cylindrical, frustoconical or funnel-shaped. Thus, the hollow body remains, but only the tunnel elements are removed and replaced with those which adapt to the dimensions of the new target insect. The diameter of the upper portion of the tunnel element is greater than that of the lower portion so as to facilitate its insertion in the insert holes and to avoid as much as possible the exit of a captured insect.

According to an embodiment of the invention, tunnel elements can be grouped together in order to form a functional unit.

Advantageously, once the insect is in the tunnel, it is forced to progress unidirectionally toward the inside end thereof, and once it has fallen to the bottom of the hollow body, the insect has no possibility of coming out of the trap.

The dimensions of the entrance and the body of the tunnel must take into account the principle of thigmotactism, specific to each species of insect to be captured. Indeed, a tunnel that is too narrow is perceived by the insect as a refuge which would incite him to nest there. On the contrary, a tunnel with too large dimensions gives the insect the possibility to turn around by pivoting on itself in the tunnel, which is to be avoided. For example, for darkling beetles, the applicant has observed that the diameter of an orifice close to the size of this insect has a significantly deterrent effect on its behavior with regard to it progressing in the tunnel.

Under the effect of thigmotactism, while studying the displacement of the darkling beetles belonging to the Tenebrionidae family, their natural propensity to follow a protruding fold provided on the surface of the hollow body was observed. This propensity has also been observed in other target crawling insects of the family Blattellidae (e.g., cockroaches), Cimicoidae (e.g., bed bugs), Armadillidiidae (e.g., woodlice), Curculionidae (e.g., weevils), Bostrichidae (e.g., beetles), Lespimatidae (e.g., silverfish), as well as some spiders and flying insects such as flies, moths, wasps and hornets. Providing the protruding fold increases the probability of capture. The trap according to the invention is capable of capturing the arthropods mentioned above.

According to an embodiment of the invention, a protruding fold is provided at the upper peripheral edge of the tunnel element so as to effectively orient the direction of movement of the insect towards the opening.

Advantageously, this principle has been used successfully in the sense that an opening is provided close to at least one of the ends of the protruding fold. Therefore, the insect is urged to follow the lower part of the protruding fold, so that when it has run through the lower part of the protruding fold, it arrives at one of the ends thereof, precisely at the upper portion of the tunnel element and then at the edge of the opening. The protruding fold can extend into the tunnel.

According to an embodiment, the height of the protruding fold is at least 0.5 times the height and 2 times the length of the insect because an insect standing on its two hind legs could not overcome it, i.e., a height between 0.1 cm and 1 cm in the case of the darkling beetle.

According to the invention, the ends of the tunnels inside the hollow body do not touch each other.

According to the invention, the openings extending in tunnels are arranged so that their ends situated inside the hollow body do not face one another, in order to prevent an insect that has fallen from one tunnel located at the top to land at the inner end of a tunnel located below. Advantageously, there is enough volume inside the hollow body to allow stocking the trapped crawling insects. Indeed, even if the insert holes intended to receive the tunnel elements are placed symmetrically opposite one another, the tunnels are oriented concentrically towards the center of the hollow body, thus avoiding that the inner ends of the diametrically opposite tunnels face each other.

According to the invention, the sum of the total area of all the insert holes directly on the hollow body is between 15% and 80% of the total surface area of the hollow body. In fact, when the total surface area of the insert holes is too large, the structure of the hollow body can be weakened. The cross-section of the said insert hole may be circular, polygonal or oval, whereas the corresponding tunnel would have a cross-section of different shape. Thus, the total number of orifices that the hollow body may comprise depends on the shape, volume and total surface area of said hollow body. Advantageously, a maximized number of openings on the outer surface of the hollow body can be preferred, so as to provide insects with more possibilities for entry, for a high capture probability.

When in use, and according to the invention, when the trap as shown in FIG. 5 is provided horizontally directly on the ground, some tunnels situated below a horizontal plane passing through the central axis of the hollow body make an angle “α” called “critical angle of progression”, which is between 0° and 70° with respect to said horizontal plane passing through said central axis. When these conditions are met, the insect from the ground is allowed to progress through the tunnel and be trapped. When the angle α is greater than 70° but less than 90°, the applicant has observed that a smaller proportion of insects still manage to progress in the tunnel and get trapped.

According to the invention, the opening of the tunnel is of variable shape and dimensions. Indeed, the opening may have a circular, oval, polygonal or triangular cross section. A circular opening is preferred for insects having general morphology that can be compared to a tubular shape, and an oval opening is preferred for insects having a flat morphology.

In an alternative embodiment, an opening having well-marked angles may be adopted so as to promote thigmotactic behavior in insects; in such a case, the section of the opening may be rectangular or triangular.

In accordance with the invention, the hollow body may have the shape of a sphere, ovoid, cylinder, cone or parallelepiped, the dimensions of which must take into account the total number of insert holes of the tunnel elements, the length of the tunnels, so that their ends do not touch each other, as well as the inner volume available in the hollow body to store the insects caught before emptying.

Advantageously, the trap according to the invention is emptied by the user by separating the two elements forming the hollow body for multiple reuses afterward.

Said hollow body may be manufactured from biodegradable or non-biodegradable materials and not consumable by insects. Said materials are chosen from fossil-source or bio-based plastic polymers, polymers of plant origin, wood and its derivatives. The polymeric materials are shaped by the techniques of plastics engineering which are well known to those skilled in the art. Other materials such as metal can also be used to make the hollow body as well as the tunnel elements.

Advantageously, the hollow body as well as the tunnel elements can be made from polymers loaded with active compositions, for example attractants, so as to increase the attractiveness of the trap with respect to the insects to be captured. The processes for obtaining such polymers loaded with active compositions are disclosed by the patents FR2901172 and FR2956345. The tunnel elements which are removable thus become consumables which can be loaded with active substances, such as an attractant.

When the hollow body is a cylinder, or a parallelepiped, one of the elements may be of the removable-plug type allowing the trap to be emptied, said plug fitting with the remainder of the hollow body. In other cases, one of the elements may be one of the faces of the parallelepiped, or pyramid, hollow body which interlocks with the remainder of the trap.

According to an embodiment of the invention, the outer surface of the hollow body may have asperities or streaks or a surface grain, so as to allow the crawling insects to easily crawl up the surface to reach the openings.

When in use, the trap according to the invention can be placed in any position without impacting its operation or its effectiveness. In the case of a cylindrical, spherical or ovoid-shaped hollow body, the trap can roll on itself on the area where it is placed without giving to the trapped insects the possibility to get out.

In one embodiment of the invention, an attractant for crawling insects may be placed inside the hollow body. Such an attractant may be in solid or liquid form. Said attraction is chosen from food substances, semiochemicals, materials and substances of organic and/or mineral origin, essential oils, or animal excrements. In some cases, a liquid attractant may be incorporated into an absorbing carrier. Said absorbing carrier is chosen from fossil or bio-based plastic polymers, polymers of plant origin, wood and its derivatives. The teachings on how to incorporate a liquid composition into a carrier are disclosed in the documents FR2901172, FR2956345, FR2959100 and FR2992325, by the applicant.

In another embodiment of the invention, an insecticide for crawling insects may be placed inside the hollow body. Such an insecticide may be in solid or liquid form. A liquid insecticide may be incorporated in an absorbing carrier of the same nature as for the attractant. When the insecticide is solid, it is solubilized in a compatible solvent before being incorporated into said absorbing carrier.

In another embodiment of the invention, an insecticide is simultaneously combined with an attractant within the hollow body for an attracticidal effect against the target crawling insect.

A second object of the present invention is to provide a method for capturing a plurality of types of insects, particularly crawling insects such as litter beetles in poultry farm buildings using the trap having the characteristics described above, characterized in that, when in use, said trap is positioned in any position on a portion of the area susceptible to infestation without the captured insects being able to escape therefrom, and removing the tunnel elements for their replacement with other tunnel elements adapted to the dimensions of the new target insect.

According to one embodiment, when in use, the trap is placed in a horizontal position so that it can roll on itself to go from one location to another on a portion of said area.

Indeed, when an ovoid, round or cylinder-shaped trap is placed directly on the ground in a farm building, the poultry are likely to either walk on it or hit it, causing an uncontrolled displacement thereof from one place to another on the ground, allowing capture in the entire building and thus on the infestation patches.

The various characteristics of the crawling insect trap that is the object of the present invention are detailed in the particular embodiments presented below:

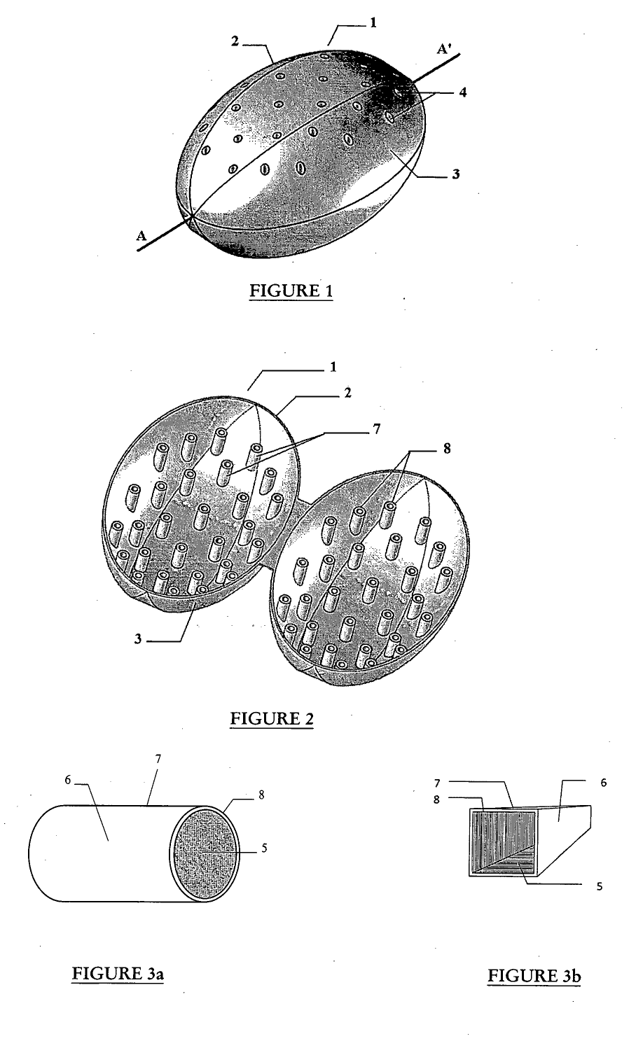

FIG. 1: perspective view of an embodiment of insect trap having an ovoid shape.

FIG. 2: longitudinal cross-section in the AA′ plane of the trap of FIG. 1.

FIG. 3a: perspective view of a cylindrical tunnel.

FIG. 3b: perspective view of a tunnel having a funnel shape with a square cross-section.

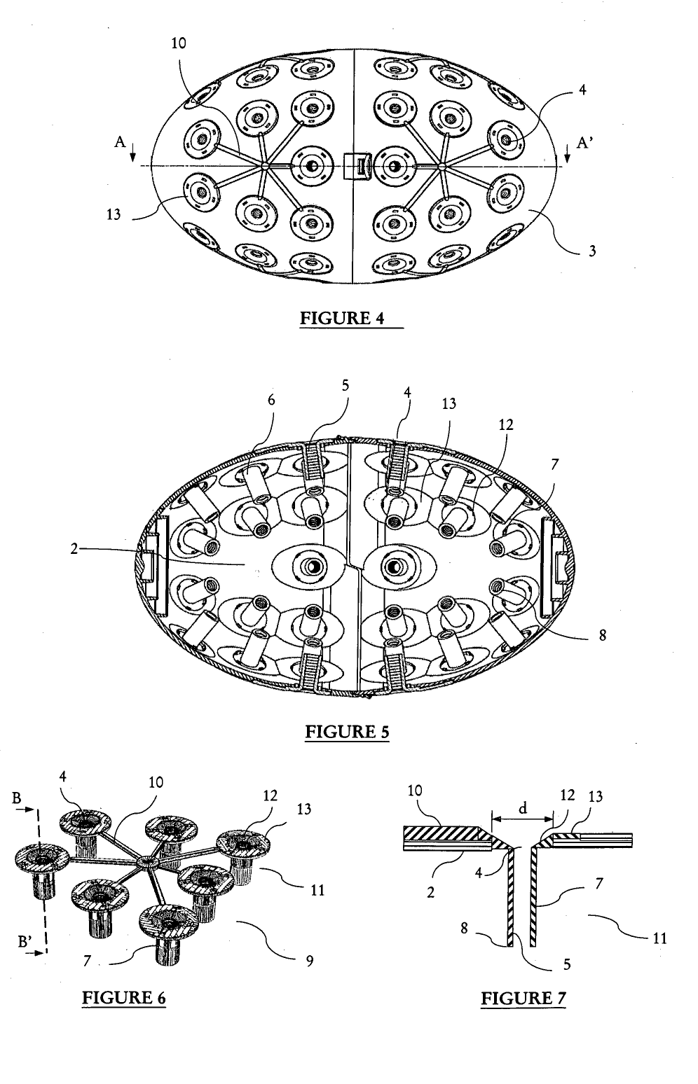

FIG. 4: front view of an ovoid-shaped trap comprising functional units.

FIG. 5: cross-section of a of the trap shown in FIG. 4 along the horizontal AA′ (longitudinal) plane.

FIG. 6: perspective view of a functional unit of the trap shown in FIG. 4.

FIG. 7: cross-section of a tunnel element along the vertical BB′ (transverse) plane.

FIG. 1 shows a crawling insect trap (1) having an ovoid-shaped hollow body (2). The outer surface (3) of the hollow body (2) is pierced by a plurality of circular openings (4). The inner diameter of the opening (4) is adapted to trap insects such as darkling beetles. The opening (4) extends in a tunnel directed toward the center of the hollow body (2), the inner wall (5) of the tunnel is rough, in contrast with the outer wall (6) which is smooth to prevent the entrapped insect from getting out through the opening (4) by climbing the tunnel.

FIG. 2 shows a longitudinal cross-section along the major axis AA′ of an ovoid-shaped crawling insect trap (1). The surface (3) of the crawling insect trap (1) is pierced by a plurality of circular openings (4) extending in a tunnel (7) oriented towards the inside of the hollow body (2). The ends (8) of the tunnels (7) inside the hollow body (2) do not touch each other.

FIG. 3a shows a tunnel (7) of which the inner end (8) is circular. The outer wall (6) is smooth to prevent crawling insects trapped inside the hollow body (2) from climbing the tunnel (7), and a rough inner wall (5) to allow crawling insects to progress into the tunnel (7).

FIG. 3b shows a tunnel (7) of a funnel shape, the end (8) thereof being rectangular. The inner wall (5) is rough, in contrast with the outer wall (6) which is smooth.

FIG. 4 shows a prototype representing a front view of an ovoid-shaped trap (1) comprising functional units (9). Each functional unit (9) comprises seven tunnel elements (7), provided, at their upper portion (13), into the insert holes on the surface (3) and maintained together at a center of the functional unit by projecting folds (10) emerging at the openings (4).

FIG. 5 shows how the tunnels 7 are arranged inside the hollow body 2 provided in a horizontal position along the plane AA′ represented in FIG. 4. Even though the openings 4 of the tunnels 7 are arranged symmetrically opposite each other, the tunnels (7) are oriented towards the center of the hollow body (2), thus preventing the ends (8) of the diametrically opposite tunnels (7) from being opposite each other. The upper portion (13) of the tunnel element (11) is inserted into the insert hole via the inclined portion (12) and the lower portion of the tunnel element if formed by a tunnel (7) of which the inner wall (5) is rough and the outer wall (6) is smooth. The inclined portion (12) is an integral part of the structure of the upper portion (13), the purpose of which is to ensure the insertion of the tunnel element (11) in the insert hole.

FIG. 6 shows a functional unit (9) comprising seven tunnel elements (11). Each tunnel element (11) has an upper portion (13) of which the portion (12) is slightly inclined towards the center of the opening (4) and a lower portion corresponding to the tunnel (7), individually connected by protruding folds (10) which converge towards the center of the unit (9); one of the ends of each of the protruding folds (10) is directly connected to a tunnel element (7) at its upper portion (13).

FIG. 7 shows a tunnel element (11) comprising cylindrical tunnels (7) of which the section along the BB′ plane, shown in FIG. 6, is substantially T-shaped, including the upper portion (13) and, in the middle thereof, the inclined portion (12); the lower edges of the inclined portion (12) delimit the circumference of the opening (4). The distance “d” represents the diameter of the insert hole (not shown) provided directly on the surface of the hollow body (2) for receiving the upper portion (13) of the tunnel element (11). After following the protruding fold (10), the insects get into the opening (4) of the cylindrical tunnel (7) via the inclined portion (12) of the upper portion (13) of the tunnel element (11) and fall into the trap after passing the end (8).

The invention is exemplified in the examples below. Of course, the scope of the objects as claimed is not limited to the type of insect discussed or to the exemplary embodiments.

### EXAMPLE 1

The Applicant has found that some poultry farm buildings are invaded by litter beetles, Alphitobius diaperinus, which concentrate around waterers and feeders, and shelter in the litter box. Litter beetle populations can reach hundreds of thousands of individuals (Axtell & Arends 1990; Dunford & Kaufman 2012). Moreover, the lifetime of the litter beetles is long enough to allow them to invade several successive poultry farms. An adult A. diaperinus measures on average 0.5 cm in length for about 0.4 cm in waist circumference, i.e., the width, and 0.5 cm in height.

By way of comparison, traps marketed under the trademark PALMatrap® are tested at the same time and under the same conditions as the traps according to the invention. The PALMatrap® trap includes a pyramid-shaped hollow body, with a circular base of 34 cm in diameter, and 22 cm high. A cylindrical container which is 23 cm in diameter and 10 cm high is placed inside the hollow body to collect the insects caught. The upper part of the pyramidal hollow body has a circular aperture 8.5 cm in diameter to allow the beetles to access the trap. When in use, the PALMatrap® trap is semi-buried and must be placed in a vertical position.

The trap according to the invention comprises an ovoid-shaped hollow plastic body of a 11 cm long minor axis and of a 20 cm long major axis, pierced with 56 circular openings distributed on its outer surface (FIG. 1). Said hollow body is formed by two half-ovoids interlocking with one another. Each opening extends as a tunnel 3 cm long and 0.7 cm in inner diameter. The inner wall of the tunnel is rough, while the outer wall is smooth. The surface of the hollow body has been sanded to create asperities in order to facilitate the movement of the darkling beetles. 50 g of chicken droppings are used as an attractant and are introduced into the hollow body. The experiments were carried out during 15 days. Nine traps with the parameters mentioned above are placed directly on the ground and are distributed in the following locations:
3 traps by the waterers,
3 traps by the feeders,
3 traps in the litter.

At the end of the experiments, the hollow body is emptied by separating the two elements and then counting the total number of captured darkling beetles. The results obtained are summarized in Table 1 below:

TABLE 1
Average number of darkling beetles captured per trap

| | | Number | Number | Number of | |
|---|---|---|---|---|---|
| | | of | of | captured | |
| Trap | Attractive | openings | replicas | beetles | Place |
| PALMatrap ® | No | 1 | 3 | 170 | Waterer |
| Ovoid | No | 56 | 3 | 202 | |
| Ovoid | Yes | 56 | 11 | 717 | |
| PALMatrap ® | Yes | 1 | 3 | 509 | Feeder |
| Ovoid | Yes | 56 | 8 | 703 | |
| PALMatrap ® | No | 1 | 3 | 218 | Litter |
| Ovoid | No | 56 | 5 | 1253 | |

It can be seen that the average number of darkling beetles captured by the ovoid trap according to the invention is greater than that of the PALMatrap® trap, regardless of the chosen location, with or without attractant.

The darkling beetles penetrate indifferently into the openings which extend as tunnels. The tests have shown that no darkling beetle has taken refuge in the tunnel during its progression towards the end inside the hollow body. Similarly, no darkling beetle has been able to turn around by pivoting on itself once it is in the tunnel. It was found that, on average, 20% to 40% of the captured darkling beetles have entered through tunnel openings located below a horizontal plane passing through the central axis of the hollow body forming an angle α between 0° and 70° with respect to said horizontal plane passing through said central axis. It was found that, on average, 3% to 5% of the captured darkling beetles have entered through the tunnel openings for which the angle α>70°.

### Assessment of How Inclined Darkling Beetles Are to Keep Moving Along the Lower Part of the Protruding Fold

To study the behavior change of darkling beetles in a laboratory environment, two protocols were put in practice to assess how inclined the darkling beetles are to cross over obstacles or rather to follow them, thus highlighting thigmotactism in their behavior.

To do this, in a first protocol, the average distance on which a darkling beetle will go along, rather than cross over, an obstacle encountered on its course, is measured. Three different obstacle heights (0 cm, 0.1 cm and 0.5 cm) were tested for a total of 10 test trials per height, demonstrating that as soon as an obstacle, even a few millimeters high, is placed on their way, the darkling beetles tend to follow it over a length that is in relation with the height of the obstacle, starting from a height of 0.1 cm (Mann-Whitney test, W=7.5, p<0.01, Graph 1). At a height of 0.5 cm, that is, the height of the darkling beetle, all the darkling beetles run along the lower part of the obstacle, without crossing it, on a distance of at least 10 cm. The stars show a significant difference according to a Mann-Whitney test compared to a height of 0 cm at p<0.01 (**) and p<0.001 (***).

In the second protocol, there was provided a group of 10 darkling beetles in a small enclosure (3.5 cm×3.5 cm) delimited by an obstacle whose height varies according to the tests (0 cm, 0.5 cm, 1 cm and 2 cm). The results (Graph 2) show that the higher the obstacle, the longer the darkling beetles take time to cross them. They cross statistically similarly an obstacle of a height from 0 cm to 0.5 cm Student's test>0.05), but take significantly longer to overcome an obstacle with a height of 1 cm (4.2 times longer: Student t=9.385, p<0.001) or 2 cm (7.3 times longer: Mann-Whitney test, W=0, p<0.001).

### EXAMPLE 2

### Fly Trap

In laboratory conditions, the hollow body of the trap described in Example 1 was replaced by a trap as shown in FIG. 4. Both traps have the same shape, but only one element of the hollow body is used to capture houseflies (Musca domestica). The adult housefly is 1 cm long on average and has a width of about 0.5 cm at its waist and a wingspan of about 1.5 cm between the ends of its wings along a transverse plane. Within the context of the invention, the width of the fly refers to its wingspan. The traps were tested simultaneously, spaced from at least 1 m and placed inside a room (2.5 cm×2 m×2.6 m high) having a controlled temperature (22° C.±1° C.) and a slight overpressure to avoid air pollution. Five other tests were made by interchanging the traps to verify that their position in the room does not impact capture. During different test sessions, six traps were tested, with their properties summarized in the table below:

TABLE 2
trapping efficiency of flies vs. tunnel size and shape

| | | Tunnel | Inside | | Trapping |
|---|---|---|---|---|---|
| Trap | Number of | Length | Diameter of | Tunnel | efficiency |
| # | Apertures | (cm) | Tunnel (cm) | Shape | (%) |
| 1 | 28 | 3 | 0.8 | cylindrical | 0 |
| 2 | 28 | 2 | 1.9 | cylindrical | +++ |
| 3 | 28 | 5 | 2 à 1 | funnel | ++++ |
| 4 | 28 | 1.3 | 0.8 | cylindrical | 0 |
| 5 | 20 | 2.5 | 2.1 | cylindrical | ++ |
| 6 | 12 | 2.5 | 2.1 | cylindrical | + |

Generally, the tests have shown that the greater the number of openings, the greater is the capture rate (traps 5 and 6). However, tunnel parameters such as size (length and inner diameter) and shape (cylindrical or frustoconical) are also crucial as they condition how inclined flies are to enter a trap instead of another one.

It should be noted that once captured, 64.2%±19.4% of flies remain captive and do not get to find the exit, in particular when the tunnel length is at least twice their own length. The frustoconical shape is the shape that minimizes the number of captured flies getting out.

1. Insect trap (1) comprising a hollow body (2) formed by two elements interlocking with each other, the outer surface (3) of said hollow body (2) is pierced with a plurality of openings (4) allowing the target insect to get into the trap, each opening (4) extending as a tunnel (7) oriented into the hollow body (2), wherein removable tunnel elements (11) are inserted onto the surface (3) of said hollow body (2) at their upper portion (13) which fits with the insert holes provided on the hollow body (2), said tunnel element (11) comprising a lower portion corresponding to the tunnel (7), the inner diameter and length thereof being adaptable to the dimensions of the target insect so as to force said insect inside the tunnel to move unidirectionally toward inside the hollow body (2) without allowing it to turn around by pivoting on itself, over an entire length or at least a portion of said tunnel (7), and wherein the inner wall (5) of said tunnel (7) is rough to allow the insect to move on in the tunnel, whereas the outer wall (6) is smooth to prevent insects trapped inside the hollow body (2) to crawl up said tunnel (7) to get out by the opening (4).

2. The trap according to claim 1, wherein the inner diameter of said tunnel (7) is between 1.3 and 2 times the width of said target insect, namely the longest axis in the front plane of said insect, and the length of said tunnel (7) is between 2 and 7 times the length of said insect, namely the longest axis in the sagittal plane of said insect.

3. The trap according to claim 2, wherein the length of the tunnel (7) is between 1 cm and 4 cm and the inner diameter is between 0.5 cm and 0.8 cm for the darkling beetle.

4. The trap according to claim 1, wherein the size parameters of the tunnel (7), comprising the inner diameter and the length of the tunnel (7), can be lengthened or shortened.

5. The trap according to claim 1, wherein the tunnel elements (11) are provided symmetrically opposite each other, the tunnels (7) being oriented concentrically toward the center of the hollow body (2) avoiding the inner ends (8) of the tunnels (7) diametrically opposed to face each other.

6. The trap according to claim 5, wherein the tunnel elements (11) are grouped so as to form a functional unit (9).

7. The trap according to claim 1, wherein a protruding fold (10) is provided at an upper portion (13) of the tunnel element (11) so as to orient efficiently the moving direction of the insect toward the opening (4).

8. (canceled)

9. The trap according to claim 9, wherein the height of the protruding fold (10) ranges between 0.5 cm and 1 cm for the litter beetle.

10. The trap according to claim 7, wherein the protruding fold (10) extends up to inside the tunnel (7).

11. The trap according to claim 1, wherein, when in use, when said trap is provided directly on the ground, the tunnels (7) positioned below a horizontal plane passing by the central axis of the hollow body (2) form an angle <<α>> comprised between 0° and 70° with respect to said horizontal plane to allow insects to progress into the tunnels (7).

12. The trap according to claim 1, wherein, a sum of the total surface of all insert holes provided on the hollow body (2) is between 15% and 80% of the total surface of the hollow body (2).

13. The trap according to claim 1, wherein the outer surface (3) of the hollow body (2) comprises asperities, streaks, or surface grain.

14. The trap according to claim 1, wherein said hollow body (2) and the tunnel elements (11) are made of biodegradable or non-biodegradable materials from fossil-source or bio-based plastic polymers, polymers of plant origin, or wood and its derivatives.

15. The trap according to claim 1, wherein said hollow body (2) and the tunnel elements (11) are made of metal.

16. The trap according to claim 5, wherein the tunnel element (11) is loaded with active substances, such as an attractant.

17. The trap according to claim 10, wherein said hollow body (2) has a shape selected among the following: sphere, ovoid, cylinder, pyramid, cone or parallelepiped.

18. (canceled)

19. A method to capture a plurality of insect types, particularly crawling insects such as darkling beetles in poultry farm buildings using the trap of claim 1, wherein, when in use, the trap (1) is provided in any position on a portion of the area susceptible to infestation without allowing said trapped insects to escape therefrom and wherein the tunnel elements (11) are removed for replacement by other tunnel elements (11) adapted to the dimension of a new target insect.

20. The method according to claim 17, wherein the trap (1) is provided in a horizontal position allowing the trap to roll on itself to go from one location to another on a portion of said area.

21. The trap according to claim 9, wherein the protruding fold (10) extends up to inside the tunnel (7).

22. The trap according to claim 6, wherein the tunnel element (11) is loaded with active substances, such as an attractant.
